(19) United States
(12) Patent Application Publication
(10) Pub. No.: US 2022/0259902 A1
(43) Pub. Date: Aug. 18, 2022

(54) MODULAR ATTACHMENT MECHANISM AND METHOD

(71) Applicant: Lear Corporation, Southfield, MI (US)

(72) Inventors: Arjun YETUKURI, Rochester Hills, MI (US); David ABDELLA, Royal Oak, MI (US); David Ryan ANDERSON, Orchard Lake, MI (US); Joshua HALLOCK, Warren, MI (US)

(73) Assignee: Lear Corporation, Southfield, MI (US)

(21) Appl. No.: 17/248,976

(22) Filed: Feb. 16, 2021

(51) Int. Cl. E05C 3/22; F16B 21/02

(52) U.S. Cl. CPC E05C 3/22; E05Y 2900/50; F16B 21/02

(57) ABSTRACT

An attachment mechanism may include an assembly having an engagement member moveable between retracted and extended positions, a latch member movable between latched and unlatched positions, and a fastener member moveable between unlock and lock positions. The mechanism may include a housing configured to receive the assembly and having a receptacle formed therein to receive the engagement member in the extended position. During insertion of the assembly in the housing, the latch member may be configured to automatically move from the latched to the unlatched position and the engagement member may be configured to automatically move from the retracted to the extended position into the receptacle. In response to movement of the latch member to the unlatched position, the fastener member may be configured to automatically move from the unlock to the lock position to lock the engagement member in the extended position for attachment of the assembly and housing.

### TECHNICAL FIELD

The following relates to an attachment mechanism and a method for attaching modules with such an attachment mechanism.

### BACKGROUND

In the automotive industry, modularity is under consideration as one path to contain and/or reduce the cost of assembly in just-in-time (JIT) manufacturing. Current assembly techniques employ conventional fastening methods using, for example, bolts and/or welding. In one form, however, modularity may require assembly of modules without access to or use of such conventional fastening methods, i.e., “blind” assembly. In that regard, blind attachment systems and/or techniques are known and have been used, for example, in bank vaults and computer docking stations. Current assembly techniques utilizing conventional fastening methods do not lend themselves to modular assembly.

Nevertheless, in modularity involving blind assembly, serviceability of the modules involved and/or their components is still needed. As a result, there exists a need for an attachment mechanism and a method using such an attachment mechanism that would facilitate such a form of modularity in order to reduce manufacturing costs while still providing for serviceability.

That is, such an attachment mechanism and method would facilitate blind assembly or attachment of modules, yet still allow or enable serviceability of such modules and/or their components. In that regard, members or carriers of such an attachment mechanism would engage with a module to provide a physical interface or a mechanical or structural connection in order to transfer load. Members or carriers of such an attachment mechanism may also establish, complete, or provide an electrical connection as the modules engage, which electrical connection may enable, allow, or provide for electrical power transfer or control signal or data communications.

### SUMMARY

According to one non-limiting exemplary embodiment described herein, an attachment mechanism is provided. The attachment mechanism may comprise an assembly including an engagement member moveable between a retracted position and an extended position, a latch member movable between a latched position and an unlatched position, and a fastener member moveable between an unlock position and a lock position. The attachment mechanism may further comprise a housing configured to receive the assembly, the housing having a receptacle formed therein configured to receive the engagement member of the assembly in the extended position. During insertion of the assembly into the housing, the latch member of the assembly may be configured to automatically move from the latched position to the unlatched position and the engagement member of the assembly may be configured to automatically move from the retracted position to the extended position into the receptacle of the housing. In response to movement of the latch member to the unlatched position, the fastener member is configured to automatically move from the unlock position to the lock position to lock the engagement member in the extended position for attachment of the assembly to the housing.

According to another non-limiting exemplary embodiment described herein, an attachment mechanism is provided. The attachment mechanism may comprise an assembly including an engagement member moveable between a retracted position and an extended position and a latch member movable between a latched position and an unlatched position, wherein the engagement member is configured to be held in the retracted position by the latch member in the latched position. The attachment mechanism may further comprise a housing configured to receive the assembly, the housing having a receptacle formed therein configured to receive the engagement member of the assembly in the extended position. During insertion of the assembly into the housing, the latch member of the assembly may be configured to automatically move from the latched position to the unlatched position and, in response to movement of the latch member to the unlatched position, the engagement member of the assembly may be configured to automatically move from the retracted position to the extended position into the receptacle for attachment of the assembly to the housing.

According to yet another non-limiting exemplary embodiment described herein, a method for attaching a first component to a second component is provided. The method may comprise inserting an assembly associated with the first component into a housing associated with the second component and configured to receive the assembly, wherein the assembly includes an engagement member moveable between a retracted position and an extended position, a latch member movable between a latched position and an unlatched position, and a fastener member moveable between an unlock position and a lock position, and wherein the housing has a receptacle formed therein configured to receive the engagement member of the assembly in the extended position. The method may further comprise automatically moving the latch member from the latched position to the unlatched position during insertion of the assembly into the housing, and automatically moving the engagement member of the assembly from the retracted position to the extended position into the receptacle of the housing during insertion of the assembly into the housing. The method may further comprise, in response to movement of the latch member to the unlatched position, automatically moving the fastener member from the unlock position to the lock position to lock the engagement member in the extended position for attachment of the assembly to the housing.

A detailed description of these and other non-limiting exemplary embodiments of an attachment mechanism and a method for attaching modules with such an attachment mechanism is set forth below together with the accompanying drawings.

### BRIEF DESCRIPTION OF THE DRAWINGS

FIGS. 1A and 1B are cross-sectional views of an attachment mechanism according to one non-limiting exemplary embodiment of the present disclosure;

FIGS. 2A-2F are cross-sectional views of an attachment mechanism according to another non-limiting exemplary embodiment of the present disclosure; and

FIGS. 3A and 3B are perspective views of an engagement member and a fastener member(s) of an attachment mechanism according to the non-limiting exemplary embodiment of

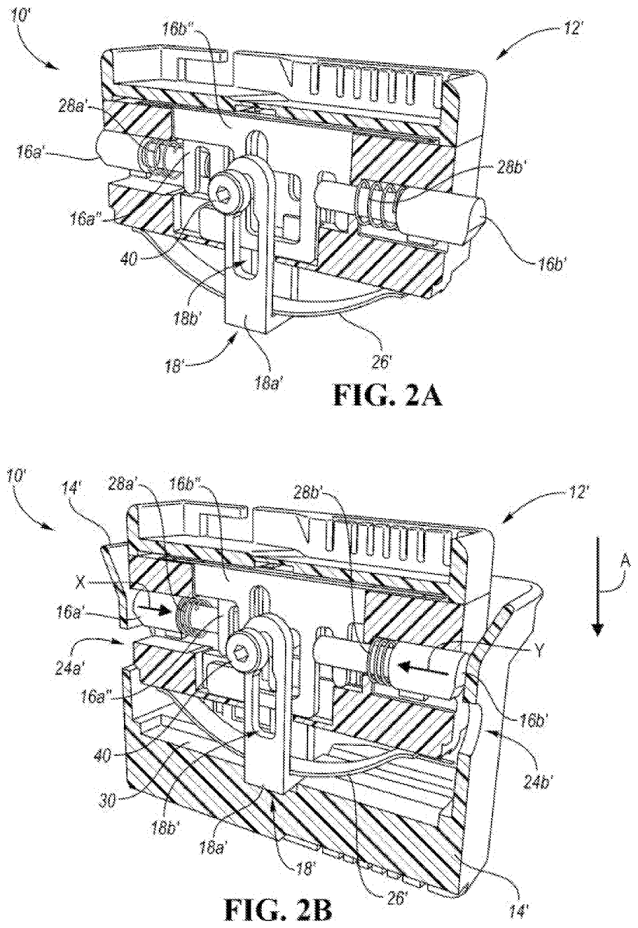

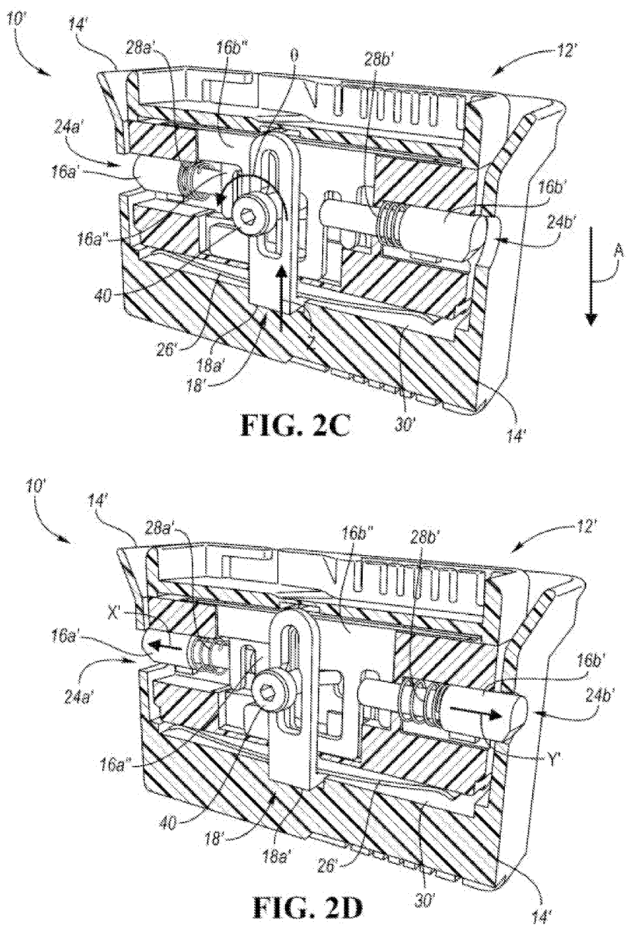

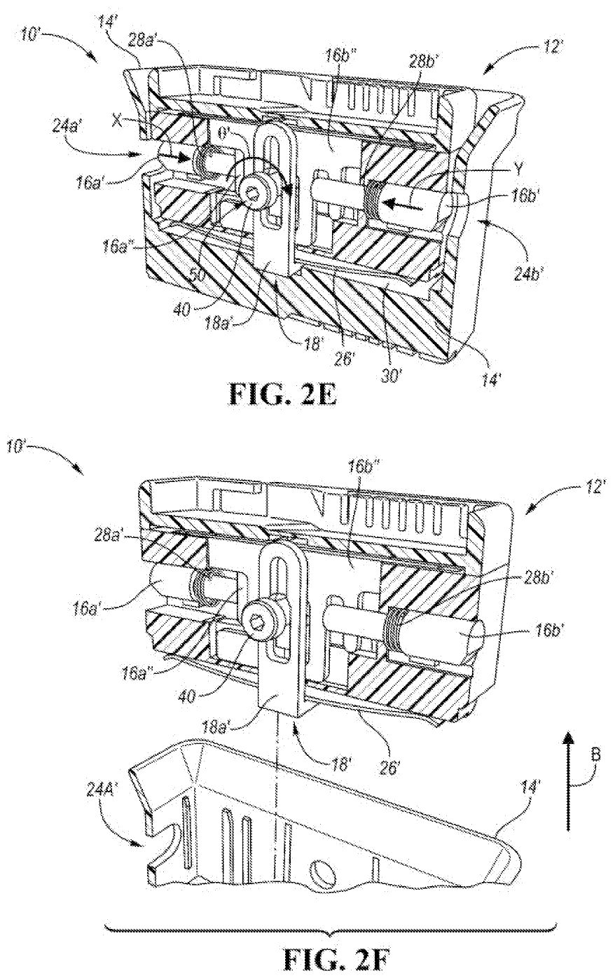

FIGS. 2A-2F of the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components, elements, features, items, members, parts, portions, or the like. Therefore, specific structural and functional details disclosed herein are not to be interpreted as limiting, but merely as a representative basis for teaching one skilled in the art.

With reference to the Figures, a more detailed description of non-limiting exemplary embodiments of an attachment mechanism and a method for attaching modules with such an attachment mechanism will be provided. For ease of illustration and to facilitate understanding, like reference numerals may be used herein for like components and features throughout the drawings.

As previously described, modularity is under consideration in the automotive industry as one path to contain and/or reduce the cost of assembly in just-in-time (JIT) manufacturing. Current assembly techniques employ conventional fastening methods using, for example, bolts and/or welding. In one form, however, modularity may require assembly of modules without access to or use of such conventional fastening methods, i.e., “blind” assembly. Nevertheless, in modularity involving blind assembly, serviceability of the modules involved and/or their components is still needed.

As a result, as also previously described, there exists a need for an attachment mechanism and a method using such an attachment mechanism that would facilitate modularity involving blind assembly or attachment of modules to reduce manufacturing costs, yet still allow or enable serviceability of such modules and/or their components. In that regard, members or carriers of such an attachment mechanism would engage with a module to provide a physical interface or a mechanical or structural connection in order to transfer load. Members or carriers of such an attachment mechanism may also establish, complete, or provide an electrical connection as the modules engage, which electrical connection may enable, allow, or provide for electrical power transfer or control signal or data communications.

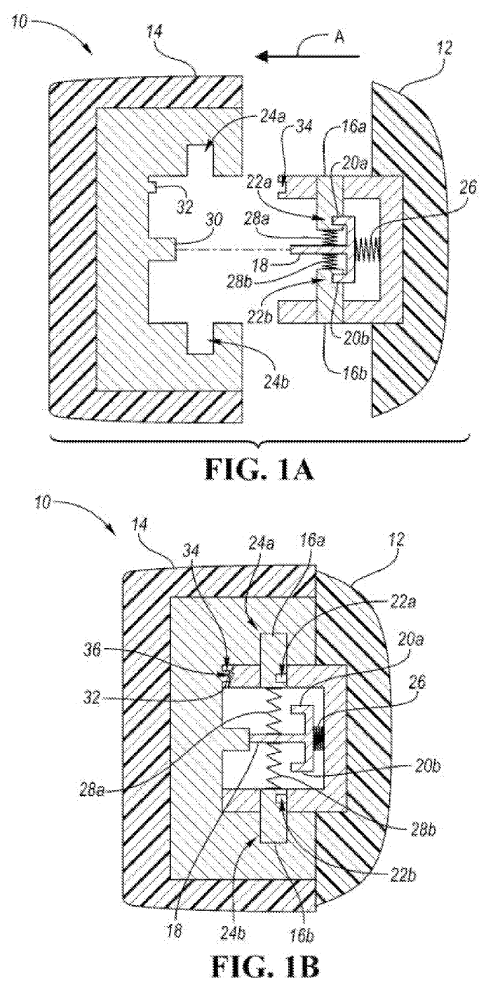

In that regard, FIGS. 1A and 1B are cross-sectional views of an attachment mechanism 10 according to one non-limiting exemplary embodiment of the present disclosure. As seen therein, the attachment mechanism 10 may comprise an assembly 12, which may be referred to as a male assembly, and a housing 14, which may be referred to as a female housing.

The assembly 12 may include one or more engagement members 16a, 16b moveable between a retracted position (FIG. 1A) and an extended position (FIG. 1B). The assembly 12 may also include a latch member 18 movable between a latched position (FIG. 1A) and an unlatched position (FIG. 1B). As seen in FIGS. 1A and 1B, each engagement member 16a, 16b may be configured to be held in the retracted position by the latch member 18 when the latch member 18 is in the latched position. In that regard, the latch member 18 may be provided with one or more projections 20a, 20b and each engagement member 16a, 16b may have a receptacle 22a, 22b formed therein which may be configured to receive a projection 20a, 20b of the latch member 18.

As also seen in FIGS. 1A and 1B, the housing 14 may be configured to receive the assembly 12. In that regard, the housing 14 may have one or more receptacles 24a, 24b formed therein, each of which may be configured to receive an engagement member 16a, 16b of the assembly 12 when such an engagement member 16a, 16b is in the extended position. During insertion (see arrow A) of the assembly 12 into the housing 14, the latch member 18 of the assembly 12 may be configured to automatically move from the latched position (FIG. 1A) to the unlatched position (FIG. 1B). In response to movement of the latch member 18 to the unlatched position, each of the engagement members 16a, 16b of the assembly 12 may be configured to automatically move from the retracted position (FIG. 1A) to the extended position (FIG. 1B) into the associated receptacle 24a, 24b formed in the housing 14, thereby providing for attachment of the assembly 12 to the housing 14.

In that regard, latch member 18 may be provided or configured to cooperate with a spring 26, which may be a coil spring. The spring 26 may be configured to bias the latch member 18 toward the latched position. Similarly, each engagement member 16a, 16b may be provided or configured to cooperate with a spring 28a, 28b, which also may be a coil spring. Each spring 28a, 28b may be configured to bias the associated engagement member 16a, 16b toward the extended position.

Moreover, the housing 14 may be configured to contact the latch member 18 during insertion (see arrow A) of the assembly 12 into the housing 14. As seen in FIGS. 1A and 1B, the housing 12 may be provided with a surface 30, which may be configured to contact the latch member 18 during such insertion of the assembly 12 into the housing 14. The latch member 18 of the assembly 12 may likewise be configured to contact the housing 14, such as the surface 30 of the housing 14, during such insertion.

As a result, during insertion of the assembly 12 into the housing 14, the latch member 18 may contact the surface 30 of the housing 14, which contact may actuate or automatically move the latch member 18 (against the force of the spring 26, which is compressed as a result) from the latched position (FIG. 1A) to the unlatched position (FIG. 1B). In such a fashion, the projections 20a, 20b of the latch member 18 are removed from the receptacles 22a, 22b of the engagement members 16a, 16b. In turn, each spring 28a, 28b (which had previously been compressed) may actuate or automatically move the associated engagement member 16a, 16b from its retracted positions (FIG. 1A) to its extended positions (FIG. 1B) into the associated receptacle 24a, 24b formed in the housing 14. In such a fashion, the assembly 12 is thereby attached to the housing 14.

Still referring to FIGS. 1A and 1B, the housing 14 may be provided with an orientation or polarization tab 32 which may be configured to cooperate with a corresponding orientation or polarization receptacle 34 which may be formed in the assembly 12. As those of ordinary skill will understand, the tab 32 may alternatively be provided on the assembly 12 and the receptacle 34 may likewise alternatively be formed in the housing 14. The tab 32 and the receptacle 34 may also be configured to, upon insertion of the tab 32 into the receptacle 34, establish, complete, or provide an electrical connection 36 as the assembly 12 and the housing 14 engage and are attached. In that regard, such an electrical connection 36 may enable, allow, or provide for electrical power transfer or control signal or data communications between the assembly 12 and the housing 14. Alternatively, one or more of the engagement members 16a, 16b and one or more of the receptacles 24a, 24b may comprise an electrically conductive material or include an electrically conductive portion which, when the engagement member 16a, 16b is in the extended position (FIG. 1B) in the associated receptacle 24a, 24b of the housing 14 and the assembly 12 is attached to the housing 14, may establish, complete, or provide an electrical connection within the housing 14 (e.g., across one or more of the receptacles 24a, 24b).

In that regard, it should be noted that assembly 12 (including receptacle 34), housing 14 (including receptacles 24a, 24b, surface 30, and tab 32), engagement members 16a, 16b (including receptacle 22a, 22b), latch member 18 (including projections 20a, 20b), spring 26, and springs 28a, 28b may comprise electrically conductive or electrically insulative materials having appropriate density, gauge, tensile strength, and/or other physical properties to enable, provide, and/or accomplish the mechanical and/or electrical functions described herein. It should also be noted that the assembly 12 and the housing 14 may be integrated with, incorporated in, or attached to respective modules and/or components to thereby provide for mechanical and/or electrical attachment of such modules and/or components. In that regard, such modules and/or components may comprise, as an example only, members or portions of a vehicle seat back frame. In such an example, the assembly 12 may be integrated with, incorporated in, or attached to one frame member, such as a side frame member, and the housing 14 may be integrated with, incorporated in, or attached to another frame member, such as a top frame member, in order to accomplish mechanical and/or electrical attachment of the vehicle seat side frame member to the vehicle seat top frame member by attachment of the assembly 12 and the housing 14 as described herein. As those of ordinary skill will understand, the locations of the assembly 12 and the housing 14 could be reversed in another example between the side frame member and the top frame member.

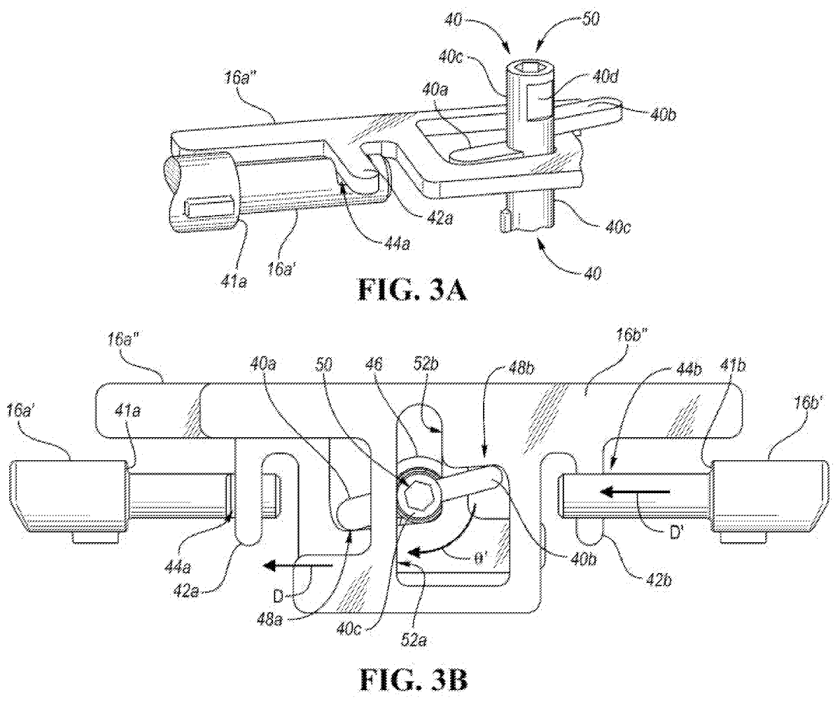

Referring now to FIGS. 2A-2F, cross-sectional views are shown of an attachment mechanism 10′ according to another non-limiting exemplary embodiment of the present disclosure. In that regard, FIGS. 3A and 3B show perspective views of engagement members 16a′, 16a″, 16b′, 16b″ and a fastener member 40 of an attachment mechanism 10′ according to the non-limiting exemplary embodiment of FIGS. 2A-2F of the present disclosure.

As seen in FIGS. 2A-2F, the attachment mechanism 10′ may comprise an assembly 12′, which may be referred to as a male assembly, and a housing 14′, which may be referred to as a female housing. The assembly 12′ may comprise one or more engagement members 16a′, 16a″, 16b′, 16b″ moveable between a retracted position (FIGS. 2B, 2C, 2E, 2F) and an extended position (FIGS. 2A, 2D). The assembly 12′ may also comprise a latch member 18′ movable between a latched position (FIGS. 2A, 2B) and an unlatched position (FIG. 2C-2F). The assembly 12′ may further comprise a fastener member 40 moveable between an unlock position (FIGS. 2E, 2F) and a lock position (FIGS. 2D, 3A, 3B).

The attachment mechanism 10′ may also comprise a housing 14′, which may be configured to receive the assembly 12′. The housing 14′ may having one or more receptacles 24a′, 24b′ formed therein, each of which may be configured to receive an associated engagement member 16a′, 16b′ of the assembly 12′ in the extended position (FIGS. 2A, 2D). In that regard, during insertion of the assembly 12′ into the housing 14′ (see arrow A shown in FIGS. 2B, 2C), the latch member 18′ of the assembly 12′ may be configured to automatically move from the latched position (FIGS. 2A, 2B) to the unlatched position (FIG. 2C-2F) and each engagement member 16a′, 16b′ of the assembly 12′ may be configured to automatically move from the retracted position (FIGS. 2B, 2C, 2E, 2F) to the extended position (FIGS. 2A, 2D) into the associated receptacle 24a′, 24b′ of the housing 14′. In response to movement of the latch member 18′ to the unlatched position, the fastener member 40 is configured to automatically move from the unlock position (FIGS. 2E, 2F) to the lock position (FIGS. 2D, 3A, 3B) to thereby lock the engagement members 16a′, 16a″, 16b′, 16b″ in the extended position in its associated receptacle 24a′, 24b′ of the housing 14′, thereby providing for attachment of the assembly 12′ to the housing 14′.

As seen in FIGS. 2A-2F and 3B, each engagement member 16a′, 16a″, 16b′, 16b″ of the assembly 12′ may comprise an engagement plate 16a″, 16b″, an engagement pin 16a′, 16b′ configured to cooperate with its associated engagement plate 16a″, 16b″, and an engagement spring 28a′, 28b′ configured to bias its associated engagement member 16a′, 16a″, 16b′, 16b″ toward the extended position. In that regard, each engagement spring 28a′, 28b′ may comprise a coil spring configured to cooperate with its associated engagement pin 16a′, 16b′. Each engagement pin 16a′, 16b′ may likewise be configured to cooperate with its associated engagement spring 28a′, 28b′, such as having a surface or shoulder 41a, 41b configured to contact an engagement spring 28a′, 28b′. As seen in FIG. 2B, during insertion of the assembly 12′ into the housing 14′ (see arrow A), the engagement pins 16a′, 16b′ are forced by the housing 14′ in the directions X and Y from their extended position to their retracted positions, against the force provided by the springs 28a′, 28b′.

As best seen in FIGS. 3A and 3B, each engagement plate 16a″, 16b″ may be provided with a tab 42a, 42b and each engagement pin 16a′, 16b′ may have a notch 44a, 44b formed therein and configured to receive and/or otherwise cooperate with an associated tab 42a, 42b to attach or connect the engagement plate 16a″, 16b″ to its associated engagement pin 16a′, 16b′. As a result, each engagement pin 16a′, 16b′ and its associated engagement plate 16a″, 16b″ may be biased by the associated spring 28a′, 28b′ together as a unit and may also move together as a unit as described herein. In that regard, each engagement plate 16a″, 16b″ and its associated engagement pin 16a′, 16b′ may be configured for bi-directional transverse movement in a first plane, as shown in part by arrows X and Y in FIG. 2B.

As also seen in FIGS. 2A-2F, the latch member 18′ may comprise a latch plate 18a′ and a latch spring 26′. The latch spring 26′ may comprise a leaf spring and may be configured to bias the latch member 18′ (e.g., the latch plate 18a′) toward the latched position. The latch plate 18a′ may be configured for bi-directional transverse movement in a second plane, with movement in one direction (see arrow Z in FIG. 2C) occurring in response to contact with a surface 30′ of the housing 14′ (against the force provided by the latch spring 26′) during insertion of the assembly 12′ into the housing 14′ (see arrow A in FIGS. 2A and 2B).

As best seen in FIGS. 3A and 3B, the fastener member 40 may comprise one or more arms or cams 40a, 40b and a shaft 40c. In that regard, each of the cams 40a, 40b may be configured to extend outwardly from the longitudinal axis of the shaft 40c. The fastener member 40 may be configured for rotational movement about the longitudinal axis of the shaft 40c between the lock and unlock positions. In that regard, the fastener member 40 may further comprise a fastener spring 46, which may comprise a torsion spring. The fastener spring 46 may be configured to cooperate with the shaft 40c and bias the fastener member 40 toward the lock position. In that regard, the cams 40a, 40b of the fastener member 40 may have or be provided with offset or staggered positions or locations along the length of the shaft 40c and may be configured to cooperate with an associated engagement plate 16a″, 16b″. In response to rotation of the shaft 40c by the fastener spring 46 in the counterclockwise direction in FIG. 3B, the cams 40a, 40b of the fastener member 40 may be configured to contact associated surfaces 48a, 48b of the engagement plates 16a″, 16b″ to thereby lock the engagement members 16a′, 16a″, 16b′, 16b″ in their extended positions. That is, the cams 40a, 40b cooperate with the associated surfaces 48a, 48b of the engagement plates 16a″, 16b″ to resist or prevent movement of the engagement pins 16a′, 16b′ from their extended positions to their retracted positions.

The latch member 18′ may also be configured to cooperate with the fastener member 40. In that regard, as seen in FIGS. 2A-2F, the latch plate 18a′ may have a slot 18b′ formed therein which may be configured to receive the shaft 40c of the fastener member 40. The slot 18b′ formed in the latch plate 18a′ may have a first portion thereof configured with a first width to cooperate with one or more substantially flat surfaces 40d (see FIG. 3A) formed on the shaft 40c of the fastener member 40 to prevent rotation of the fastener member 40 when the latch member 18′ is in the latch position. In that regard, the first width of the first portion of the slot 18b′ may be less than the full diameter of the shaft 40c. The slot 18b′ formed in the latch plate 18a′ may also have a second portion thereof configured with a second width, greater than the first width and greater than the full diameter of the shaft 40c, to permit rotation of the fastener member 40 (i.e., not interfere with rotation of the shaft 40c) when the latch member 18′ is in the unlatch position.

In that regard, as seen in FIGS. 2B-2D, during insertion of the assembly 12′ into the housing 14′ in the direction of arrow A (see FIG. 2C), the latch plate 18a′ makes contact with the surface 30′ of the housing 14′, which contact may actuate or automatically move the latch plate 18′ against the force provided by the latch spring 26′ in the direction shown by arrow Z (FIG. 2C) from the latch position to the unlatch position. As well, the engagement pins 16a′, 16b′, which during insertion of the assembly 12′ into the housing 14′ were previously actuated or automatically moved by the housing 14′ against the force provided by engagement springs 28a′, 28b′ from their extended position to their retracted position (see FIG. 2B), ultimately align with the associated receptacles 24a′, 24b′ in the housing. As a result, the engagement pins 16a′, 16b′ may be actuated or automatically moved (i.e., translated in the directions X′ and Y′ shown in FIG. 2D) by the force provided by their respective engagement springs 28a′, 28b′ from their retracted positions to their extended positions (see FIG. 2D). As well, the shaft 40c and cams 40a, 40b of the fastener member, free from constraint by the latch plate 18a′, may thus be actuated or automatically moved (rotated in the direction 0 shown in FIG. 2C by the force provided by the fastener spring 46) from the unlock position to the lock position to thereby lock the engagement pins 16a′, 16b′ in their extended positions inside their associated receptacles 24a′, 24b′ in the housing 14′. In such a fashion, the engagement pins 16a′, 16b′ may provide a “snap-in” connection or attachment of the assembly 12′ and the housing 14′.

As best seen in FIGS. 2E and 3B, the fastener member 40 may be further configured for manual movement from the lock position to the unlock position. More specifically, the shaft 40c of the fastener member 40 may be have a recess 50 formed therein configured to receive a tool (not shown), such as for example a screwdriver or wrench, which may be employed by a user to manually rotate the fastener member 40, including the shaft 40c and the cams 40a, 40b, in the direction of arrows 0′ (see FIGS. 2E and 3B) against the force provided by the fastener spring 46 from the lock position to the unlock position.

In that regard, in response to movement of the fastener member 40 from the lock position to the unlock position, the engagement members 16a′, 16b′, 16a″, 16b″ may be configured to move from their extended position to their retracted position for detachment of the assembly 12′ from the housing 14′. More specifically, as seen in FIG. 3B, in response to manual rotation of the shaft 40c of the fastener member 40 in the clockwise direction of arrow 0′, the cams 40a, 40b are similarly rotated and move from the locked position shown to subsequently make contact with the surfaces 52a, 52b of the engagement plates 16a″, 16b″. Thereafter, as rotation of the cams 40a, 40b in that same clockwise direction 0′ continues, the engagement plate 16b″ moves transversely in the direction of arrow D shown in FIG. 3B. Because the engagement plate 16b″ is attached or connected to the engagement pin 16b′ (via the tab 42b of the engagement plate 16b″ received in slot 44b of the engagement pin 16b′), the engagement pin 16b′ likewise moves in the direction of arrow D′ shown in FIG. 3B. As those of ordinary skill will understand, the same manual rotation of the shaft 40c and the cams 40a, 40b of the fastener member 40 in the clockwise direction of arrow 0′ shown in FIG. 3B similarly moves the engagement plate 16a″ and the engagement pin 16a′ transversely in the opposite directions, respectively, of arrows D and D′.

In such a fashion, as seen in FIG. 2F, the engagement pins 16a′, 16b′ are moved transversely from their extended positions in the receptacles 24a′, 24b′ of the housing 14′ to their retracted positions. As the previously mentioned tool is employed by the user to hold the fastener member 40 in the unlock position, the assembly 12′ may then be removed from the housing 12′ (i.e., the assembly 12′ may be moved in the direction of arrow B). Upon removal of the assembly 14′ from the housing 12′, the user may remove the tool from the receptacle 50 of the fastener 40. As a result, the engagement springs 28a′, 28b′ may actuate or automatically move the engagement pins 16a′, 16b′ (and their associated engagement plates 16a″, 16b″) from the retracted position to the extended position. As well, with the fastener 40 free to rotate, the fastener spring 46 may actuate or automatically move the shaft 40c to a position wherein the flat surface 40d of the shaft 40c aligns with the first portion of the slot 18b′ having the first width which is less than the full diameter of the shaft 40c. As a result, the latch plate 18a′ may be actuate or automatically moved by the force provided by the latch spring 26′ to its latched position, thereby fixing the fastener member 40 in the unlock position.

In that regard, it should be noted that assembly 12′, including engagement pins 16a′, 16b′, engagement plates 16a″, 16b″, springs 28a′, 28b′, latch member 18′, spring 26′, and fastener 40, including shaft 40c, cams 40a, 40b, and spring 46, as well as the housing 14′, including receptacles 24a, 24b and surface 30, may comprise electrically conductive or electrically insulative materials having appropriate density, gauge, tensile strength, and/or other physical properties to enable, provide, and/or accomplish the mechanical and/or electrical connections and/or functions described herein. It should also be noted that the assembly 12′ and the housing 14′ may be integrated with, incorporated in, or attached to respective modules and/or components (not shown) to thereby provide for mechanical and/or electrical attachment of such modules and/or components. In that regard, such modules and/or components may comprise, as an example only, members or portions of a vehicle seat back frame. In such an example, the assembly 12′ may be integrated with, incorporated in, or attached to one frame member, such as a side frame member, and the housing 14′ may be integrated with, incorporated in, or attached to another frame member, such as a top frame member, in order to accomplish mechanical and/or electrical attachment of the vehicle seat side frame member to the vehicle seat top frame member by attachment of the assembly 12′ and the housing 14′ as described herein.

Moreover, in their extended positions in the receptacles 24a′, 24b′ of the housing 14, one or more of the engagement pins 16a′, 16b′ may establish, complete, or provide an electrical connection as the assembly 12′ and the housing 14′ engage and are attached. In that regard, such an electrical connection may enable, allow, or provide for electrical power transfer or control signal or data communications within a module or component associated with the assembly 12′ or the housing 14′, or between a module or component associated with the assembly 12′ and a module or component associated with the housing 14′. That is, one or more of the engagement pins 16a′, 16b′ may comprise an electrically conductive material or include an electrically conductive portion which, when the engagement pin 16a′, 16b′ is in the extended position in the associated receptacle 24a′, 24b′ of the housing 14′ and the assembly 12′ is attached to the housing 14′, may establish, complete, or provide an electrical connection within a module or component associated with the assembly 12′ or the housing 14′, or between a module or component associated with the assembly 12′ and a module or component associated with the housing 14′. In that regard, the module or component associated with the housing 14′ and the receptacles 24a′, 24b′ thereof may likewise comprise an electrically conductive material or include an electrically conductive portion to facilitate such an electrical connection.

Referring still to FIGS. 2A-2F, 3A and 3B, a method for attaching a first module to a second module is also provided. Such a method may comprise inserting an assembly 12′ associated with the first module into a housing 14′ associated with the second module and configured to receive the assembly, wherein the assembly includes an engagement member 16a′, 16a″, 16b′, 16b″ moveable between a retracted position and an extended position, a latch member 18′ movable between a latched position and an unlatched position, and a fastener member 40 moveable between an unlock position and a lock position, and wherein the housing 14′ has a receptacle 24a′, 24b′ formed therein configured to receive the engagement member 16a′, 16b′ of the assembly in the extended position. The method may further comprise automatically moving the latch member 18′ from the latched position to the unlatched position during insertion of the assembly 12′ into the housing 14′, and automatically moving the engagement member 16a′, 16b′ of the assembly 12′ from the retracted position to the extended position into the receptacle 24a′, 24b′ of the housing 14′ during insertion of the assembly 12′ into the housing 14′.

The method may further comprise, in response to movement of the latch member 18′ to the unlatched position, automatically moving the fastener member 40 from the unlock position to the lock position to lock the engagement member 16a′, 16b′ in the extended position for attachment of the assembly 12′ to the housing 14′. The method may also comprise manually moving the fastener member 40 from the lock position to the unlock position, and, in response to movement of the fastener member 40 from the lock position to the unlock position, moving the engagement member 16a′, 16a″, 16b′, 16b″ from the extended position to the retracted position for detachment of the assembly 12′ from the housing 14′.

The present disclosure thus describes an attachment mechanism and a method for attaching modules with such an attachment mechanism, such as for attaching modules comprising vehicle seat components. In that regard, the present disclosure describes an attachment mechanism and a method using such an attachment mechanism that facilitate modularity involving blind assembly or attachment of modules to reduce manufacturing costs, yet still allow or enable serviceability of such modules and/or their components. More specifically, members or carriers of the attachment mechanism described engage with a module to provide a physical interface or a mechanical or structural connection in order to transfer load. Members or carriers of the attachment mechanism may also establish, complete, or provide an electrically connection as the modules engage, which electrical connection may enable, allow, or provide for electrical power transfer or control signal or data communications.

As is readily apparent from the foregoing, various non-limiting embodiments of an attachment mechanism and a method for attaching modules with such an attachment mechanism have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. An attachment mechanism comprising:
an assembly including an engagement member moveable between a retracted position and an extended position, a latch member movable between a latched position and an unlatched position, and a fastener member moveable between an unlock position and a lock position; and
a housing configured to receive the assembly, the housing having a receptacle formed therein configured to receive the engagement member of the assembly in the extended position;
wherein, during insertion of the assembly into the housing, the latch member of the assembly is configured to automatically move from the latched position to the unlatched position and the engagement member of the assembly is configured to automatically move from the retracted position to the extended position into the receptacle of the housing;
wherein, in response to movement of the latch member to the unlatched position, the fastener member is configured to automatically move from the unlock position to the lock position to lock the engagement member in the extended position for attachment of the assembly to the housing.

2. The attachment mechanism of claim 1 wherein the engagement member of the assembly comprises an engagement plate, an engagement pin configured to cooperate with the engagement plate, and an engagement spring configured to bias the engagement member toward the extended position.

3. The attachment mechanism of claim 2 wherein the engagement plate and the engagement pin are configured for transverse movement in a first plane and wherein the engagement spring comprises a coil spring configured to cooperate with the engagement pin.

4. The attachment mechanism of claim 1 wherein the latch member comprises a latch plate configured to cooperate with the fastener member and a latch spring configured to bias the latch member toward the latched position.

5. The attachment mechanism of claim 4 wherein the latch plate is configured for transverse movement in a second plane in response to contact with a surface of the housing and wherein the engagement spring comprises a leaf spring.

6. The attachment mechanism of claim 1 wherein the fastener member comprises a fastener arm configured to cooperate with the engagement member and a fastener spring configured to bias the fastener member toward the lock position.

7. The attachment mechanism of claim 6 wherein the fastener member is configured for rotational movement and the fastener spring comprises a torsion spring.

8. The attachment mechanism of claim 6 wherein the fastener member is further configured for manual movement from the lock position to the unlock position and wherein, in response to movement of the fastener member from the lock position to the unlock position, the engagement member is configured to move from the extended position to the retracted position for detachment of the assembly from the housing.

9. The attachment mechanism of claim 1 wherein the assembly is part of a first module and the housing is part of a second module.

10. The attachment mechanism of claim 9 wherein the first module comprises a first vehicle seat component and the second module comprises a second vehicle seat component.

11. The attachment mechanism of claim 9 wherein the attachment of the assembly to the housing provides a mechanical connection between the first module and the second module.

12. The attachment mechanism of claim 9 wherein the attachment of the assembly to the housing provides an electrical connection between the first module and the second module or within the second module.

13. The attachment mechanism of claim 12 wherein the electrical connection is part of an electrical power circuit or a control signal or data communication circuit.

14. An attachment mechanism comprising:
an assembly including an engagement member moveable between a retracted position and an extended position and a latch member movable between a latched position and an unlatched position, wherein the engagement member is configured to be held in the retracted position by the latch member in the latched position; and
a housing configured to receive the assembly, the housing having a receptacle formed therein configured to receive the engagement member of the assembly in the extended position;
wherein, during insertion of the assembly into the housing, the latch member of the assembly is configured to automatically move from the latched position to the unlatched position and wherein, in response to movement of the latch member to the unlatched position, the engagement member of the assembly is configured to automatically move from the retracted position to the extended position into the receptacle for attachment of the assembly to the housing.

15. A method for attaching a first module to a second module, the method comprising:
inserting an assembly associated with the first module into a housing associated with the second module and configured to receive the assembly, wherein the assembly includes an engagement member moveable between a retracted position and an extended position, a latch member movable between a latched position and an unlatched position, and a fastener member moveable between an unlock position and a lock position, and wherein the housing has a receptacle formed therein configured to receive the engagement member of the assembly in the extended position;
automatically moving the latch member from the latched position to the unlatched position during insertion of the assembly into the housing;
automatically moving the engagement member of the assembly from the retracted position to the extended position into the receptacle of the housing during insertion of the assembly into the housing;
in response to movement of the latch member to the unlatched position, automatically moving the fastener member from the unlock position to the lock position to lock the engagement member in the extended position for attachment of the assembly to the housing.

16. The method of claim 15 further comprising:
manually moving the fastener member from the lock position to the unlock position; and
in response to movement of the fastener member from the lock position to the unlock position, moving the engagement member from the extended position to the retracted position for detachment of the assembly from the housing.

17. The method of claim 15 wherein the first module comprises a first vehicle seat component and the second module comprises a second vehicle seat component.

18. The method of claim 15 wherein the attachment of the assembly to the housing provides a mechanical connection between the first module and the second module.

19. The method of claim 15 wherein the attachment of the assembly to the housing provides an electrical connection between the first module and the second module or within the second module.

20. The method of claim 19 wherein the electrical connection is part of an electrical power circuit or a control signal or data communication circuit.
